(19) United States
(12) Patent Application Publication
(10) Pub. No.: US 2020/0290184 A1
(43) Pub. Date: Sep. 17, 2020

(54) MACHINING SYSTEM, FITTING DEVICE, AND METHOD FOR CONTROLLING FITTING DEVICE

(71) Applicant: SAKAI DISPLAY PRODUCTS CORPORATION, Sakai-shi, Osaka (JP)

(72) Inventor: Nobuhiro YONEZAWA, Sakai-shi, Osaka (JP)

(21) Appl. No.: 16/083,999

(22) PCT Filed: Mar. 11, 2016
(86) PCT No.: PCT/JP2016/057857

§ 371 Date: Sep. 21, 2018

(51) Int. Cl. B25B 23/00; B25B 21/00; G01J 1/04

(52) U.S. Cl. CPC B25B 23/005; G02F 1/1303; G01J 1/0411; B25B 21/00

(57) ABSTRACT

A machining system of the present invention includes: a subject to be machined, said subject having a housing and a light source provided in the housing; and a fitting device for fitting a fixing member in the housing. The subject to be machined has a light output port for outputting, to the outer side of the housing, output light outputted from the light source, said light output port being an opening formed in the housing. The fitting device is provided with: a fitting mechanism for fitting the fixing member in the housing by being driven; a light receiving device for receiving the output light outputted from the light output port; and a drive control unit for controlling the drive of the fitting mechanism on the basis of the results of the light reception performed by the light receiving device.

### TECHNICAL FIELD

The present invention relates to a machining system including a target device and a fitting device for fitting a fixing member in the target device. The present invention also relates to the fitting device and a method for controlling the fitting device.

### BACKGROUND ART

Patent Literature 1, for example, discloses a double floor installation method involving emitting a laser beam from a laser generator and receiving the laser beam, measuring a positional relationship in terms of height relative to the level of the received laser beam, and adjusting the level of a floor being installed based on a difference between a predetermined level and the measured positional relationship in terms of height.

### CITATION LIST

### Patent Literature

### [Patent Literature 1]

Japanese Patent Application Laid-Open Publication No. 9-268740

### SUMMARY OF INVENTION

### Technical Problem

Incidentally, a fixing member (for example, a small screw, a large screw, or a nail) is fitted in a through hole of a constituent part for fixing the constituent part, but the fixing member is sometimes fitted with an axial direction thereof oblique to a central axis of the through hole. In such a situation, the fixing member is unsuccessfully fitted in the through hole, or is successfully fitted in the through hole but fails to reliably fix the constituent part.

For example, a worker fixes a constituent part by fitting a screw in the constituent part using an electric screwdriver as a fitting device. In a situation in which the constituent part is a large constituent part, such as a housing of a large liquid crystal display panel, the worker may not be able to see a screw receiving site of the constituent part from the front while working, because the constituent part is difficult to move or working space is limited. In such a situation, it is not easy for the worker to fit the screw in the constituent part while holding the screw in its correct orientation.

The present invention has been made in view of the circumstances described above, and an object thereof is to provide a machining system capable of preventing a fixing member from being fitted in a tilted manner, a fitting device, and a method for controlling the fitting device.

### Solution to Problem

A machining system according to an aspect of the present invention includes a target device and a fitting device. The target device has a housing and a light source disposed within the housing. The fitting device fits a fixing member in the housing. The target device has at least one light exit opening. The at least one light exit opening is provided in the housing and lets out light emitted by the light source to an exterior of the housing. The fitting device includes a fitting mechanism, at least one light receiver, and a drive controller. The fitting mechanism is driven to fit the fixing member in the housing. The at least one light receiver receives the emitted light that has exited through the at least one light exit opening. The drive controller controls driving of the fitting mechanism based on a result of light reception by the at least one light receiver.

A fitting device according to another aspect of the present invention fits a fixing member in a housing of a target device. The target device has the housing, a light source, and at least one light exit opening. The light source is disposed within the housing. The at least one light exit opening is provided in the housing and lets out light emitted by the light source to an exterior of the housing. The fitting device includes a fitting mechanism, at least one light receiver, and a drive controller. The fitting mechanism is driven to fit the fixing member in the housing. The at least one light receiver receives the emitted light that has exited through the at least one light exit opening. The drive controller controls driving of the fitting mechanism based on a result of light reception by the at least one light receiver.

A method for controlling a fitting device according to another aspect of the present invention is for fitting a fixing member in a housing of a target device. The target device has the housing, a light source, and at least one light exit opening. The light source is disposed within the housing. The at least one light exit opening is provided in the housing and lets out light emitted by the fight source to an exterior of the housing. The method includes receiving and controlling. In the receiving, the emitted light that has exited through the at least one light exit opening is received. In the controlling, driving of a fitting mechanism for fitting the fixing member is controlled based on a result of the receiving of the emitted light.

### Advantageous Effects of Invention

According to the present invention, it is possible to prevent a fixing member from being fitted in a tilted manner.

### BRIEF DESCRIPTION OF DRAWINGS

FIG. 1 is a conceptual diagram illustrating a machining system according to Embodiment 1.

FIG. 2 is a diagram illustrating partial external appearance of a television receiver according to Embodiment 1.

FIG. 3 is a partial cross-sectional view illustrating a portion of a cross-section taken along line A-A in FIG. 2.

FIG. 4 is a diagram illustrating an electric screwdriver according to Embodiment 1 fitting a screw in the television receiver.

FIG. 5 is a functional block diagram illustrating a configuration of main elements of the electric screwdriver according to Embodiment 1.

FIG. 6 is a flowchart of a process that is performed by a controller of the electric screwdriver according to Embodiment 1.

FIG. 7 is a functional block diagram illustrating a configuration of main elements of an electric screwdriver according to Embodiment 2.

FIG. 8 is a diagram illustrating a configuration of a notification section of the electric screwdriver according to Embodiment 2.

FIG. 9 is a flowchart of a process that is performed by a controller of the electric screwdriver according to Embodiment 2.

FIG. 10 is a functional block diagram illustrating a configuration of main elements of an electric screwdriver according to Embodiment 3.

FIG. 11 is a diagram illustrating a relationship between angle of incidence and angle of refraction of emitted light received by a light receiver.

FIG. 12 is a flowchart of a process that is performed by a controller of the electric screwdriver according to Embodiment 3.

FIG. 13 is a diagram illustrating partial external appearance of a television receiver according to Embodiment 4.

FIG. 14 is a diagram illustrating an electric screwdriver according to Embodiment 4 fitting a screw in the television receiver.

### DESCRIPTION OF EMBODIMENTS

The following describes embodiments of the present invention in detail based on the drawings using an example of a machining system in which a target device is a television receiver having a liquid crystal display panel and a fitting device is an electric screwdriver.

### Embodiment 1

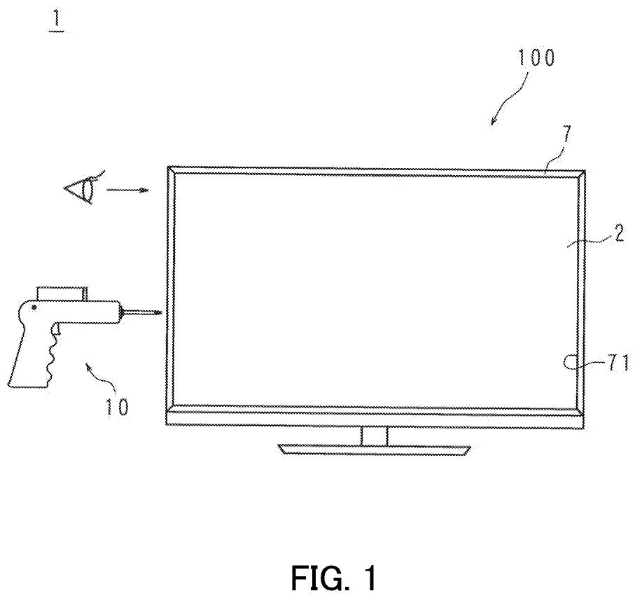

FIG. 1 is a conceptual diagram illustrating a machining system 1 according to Embodiment 1. The machining system 1 includes a television receiver 100 and an electric screwdriver 10 for performing screwing on the television receiver 100.

The television receiver 100 is for example a large television receiver. The television receiver 100 includes a rectangular liquid crystal display panel 2 for displaying images on a display surface thereof, which is a front surface. A periphery of the liquid crystal display panel 2 is surrounded by a bezel 7.

In the following description, a left-right direction in a front view of the television receiver 100 is referred to as a device lateral direction, and an up-down direction in the front view of the television receiver 100 is referred to as a device longitudinal direction. A thickness direction of the television receiver 100, which in other words is a direction from a front to a back or the back to the front of the television receiver 100, is referred to as a device thickness direction.

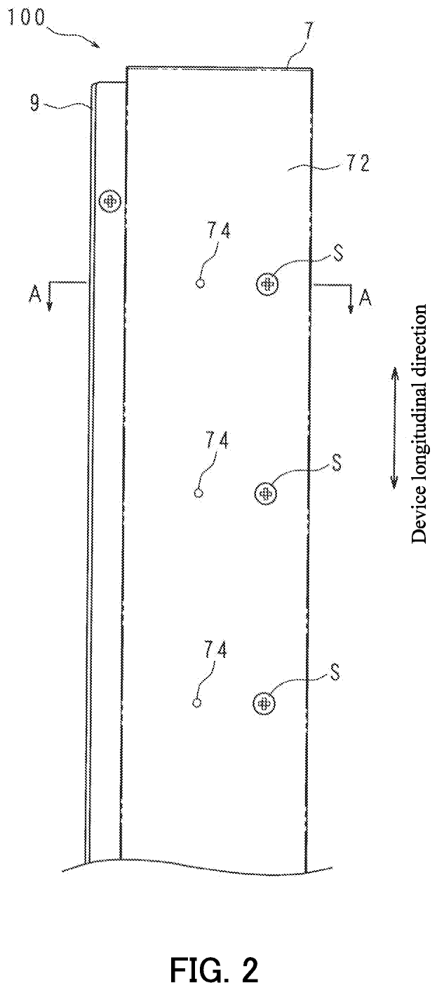

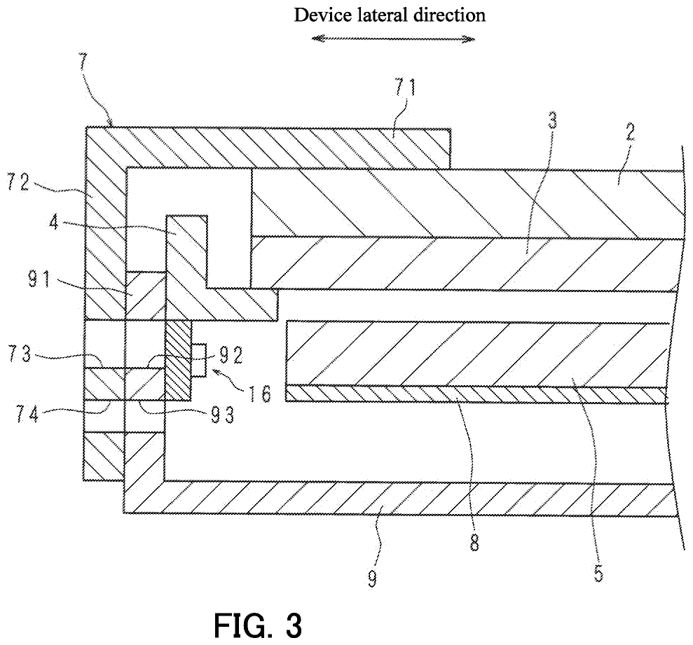

FIG. 2 is a diagram illustrating partial external appearance of the television receiver 100 according to Embodiment 1. FIG. 2 shows the television receiver 100 viewed from a direction indicated by an arrow in FIG. 1. FIG. 3 is a partial cross-sectional view illustrating a portion of a cross-section taken along line A-A in FIG. 2.

As illustrated in FIG. 3, an optical sheet 3, a light guide plate 5, and a reflective sheet 8 are disposed in the stated order on a back surface (a surface opposite to the display surface) of the liquid crystal display panel 2, and the light guide plate 5 and the reflective sheet 8 are housed in a backlight chassis 9. Light sources 16 are provided so as to each face a side surface of the light guide plate 5. Hereinafter, a surface of each of the optical sheet 3, the light guide plate 5, and the reflective sheet 8 that is toward the liquid crystal display panel 2 is referred to as a front surface thereof. Likewise, a surface of each of the optical sheet 3, the light guide plate 5, and the reflective sheet 8 that is distant from the liquid crystal display panel 2 is referred to as a back surface thereof.

As illustrated in FIGS. 1 to 3, the bezel 7 has a rectangular frame-like shape and opens toward both a front side and a back side of the television receiver 100. The bezel 7 may be a segmented bezel, which is an assembly of a plurality of components, or a one-component bezel. The bezel 7 may also be made from a metal or a resin. The following describes the bezel 7 using an example in which the bezel 7 is a metal segmented bezel to facilitate explanation.

As illustrated in FIGS. 2 and 3, the bezel 7 has side walls 72 elongated in the device longitudinal direction. At least one of the side walls 72 has a plurality of screw holes 73 that respectively receive fitting of screws S for fixing the bezel 7 to the backlight chassis 9. The screw holes 73 penetrate the side wall 72 in a thickness direction thereof and are for example aligned in the device longitudinal direction. The bezel 7 is fixed to the backlight chassis 9 through the screws S being fitted in the screw holes 73 and screw holes 92 described below.

The side wall 72 of the bezel 7 also has light exit openings 74 for letting out light emitted by the light sources 16. The light exit openings 74 are provided in the vicinity of and in one-to-one correspondence with the screw holes 73. The light exit openings 74 penetrate the side wall 72 at right angle to a plane of the side wall 72 and are for example smaller than the screw holes 73, According to the present embodiment, each of the light exit openings 74 and the corresponding screw hole 73 are in alignment with each other in the device thickness direction. However, the arrangement is not limited thereto, and each of the light exit openings 74 and the corresponding screw hole 73 may be out of alignment with each other in the device thickness direction.

The backlight chassis 9 has a rectangular parallelepiped box-like shape with one open face and includes side walls 91 respectively facing the side walls 72 of the bezel 7 and covered by the side walls 72.

As illustrated in FIG. 3, the bezel 7 includes a hollow rectangular framing portion 71 that covers a periphery of the display surface of the liquid crystal display, panel 2. The framing portion 71 has a specific length based on an end of the backlight chassis 9 on an open face side (i.e., a front side) of the backlight chassis 9 and extends inward from the side walls 72.

A cushioning member (not shown) is disposed between the framing portion 71 and the periphery of the display surface of the liquid crystal display panel 2. The framing portion 71 holds the periphery of the display surface of the liquid crystal display panel 2 through the cushioning member with pressure in the device thickness direction.

The optical sheet 3 is disposed on the back surface of the liquid crystal display panel 2. The light guide plate 5 is disposed such that the front surface thereof faces the back surface of the optical sheet 3 with a specific space therebetween. The reflective sheet 8 is disposed on the back surface of the light guide plate 5.

The optical sheet 3 disposed on the back surface of the liquid crystal display panel 2 receives light emitted by the light sources 16 and guided by the light guide plate 5, diffuses or condenses the light into more uniform light, and emits the uniform light toward the liquid crystal display panel 2. The optical sheet 3 for example includes two diffusion sheets and one prism sheet disposed between the two diffusion sheets.

A holding member 4 that holds the optical sheet 3 is provided at a periphery portion of the back surface of the optical sheet 3. The holding member 4 has an L-shaped cross-section. The holding member 4 also has a protruding portion protruding in a direction intersecting with the side wall 91 of the backlight chassis 9 (in a direction of a plane of the optical sheet 3). The protruding portion has an end in contact with the periphery portion of the back surface of the optical sheet 3 and supports the optical sheet 3.

The light guide plate 5 diffuses light emitted by the light sources 16 and entering through the side surfaces thereof, and emits the diffused light toward the optical sheet 3 from the front surface thereof. The tight guide plate 5 is for example made of a milky white resin (such as acrylic resin or polycarbonate resin containing a diffusing agent as an additive. In a configuration in which point light sources such as LEDs are used as the light sources 16, the light guide plate 5 diffuses light from each of the point light sources into uniform light and surface-emits the light from the front surface thereof.

The reflective sheet 8 has a rectangular shape corresponding to the shape of the light guide plate 5, and the front surface of the reflective sheet 8 faces the back surface of the light guide plate 5.

The backlight chassis 9 houses the light guide plate 5 and the reflective sheet 8 as mentioned above. The side walls 91 have the screw holes 92 in one-to-one correspondence with the screw holes 73 of the bezel 7 and light exit openings 93 in one-to-one correspondence with the light exit openings 74 of the bezel 7.

The screw holes 92 penetrate the side walls 91 in a thickness direction thereof and have for example the same diameter as the screw holes 73. The screw holes 92 are in positions that match positions of the screw holes 73 in the device lateral direction when the bezel 7 and the backlight chassis 9 are in a desired positional relationship (a positional relationship upon fixation). The light exit openings 93 also penetrate the side walls 91 at right angle to planes thereof and have for example the same diameter as the light exit openings 74. The light exit openings 93 are in positions that match positions of the light exit openings 74 in the device lateral direction when the bezel 7 and the backlight chassis 9 are in the desired positional relationship (the positional relationship upon fixation).

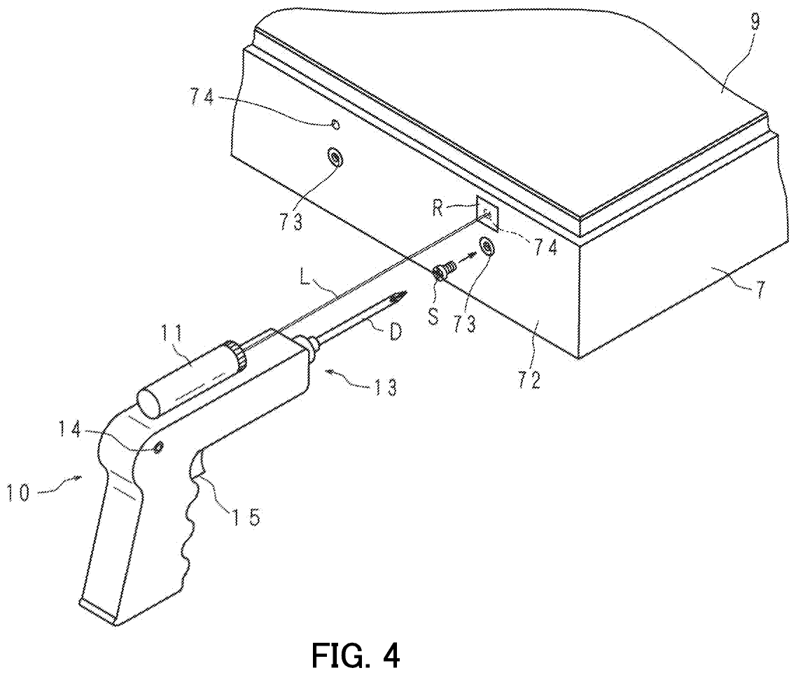

Accordingly, a portion of the light emitted by the light sources 16 exits out of the television receiver 100 through the light exit openings 93 and the light exit openings 74. The light that has exited through the light exit openings 74 and 93, which in other words is light emitted from the television receiver 100 (emitted light L (see FIG. 4)), is received by the light receiver 11 of the electric screwdriver 10 as described below. The bezel 7 is fixed to the backlight chassis 9 through the screws S being fitted in the screw holes 73 and 92 (through holes).

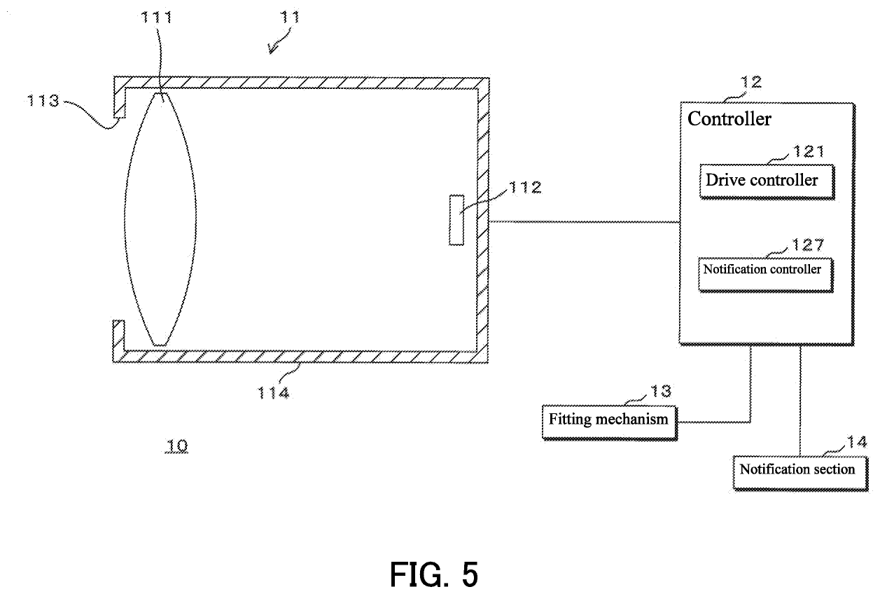

FIG. 4 is a diagram illustrating the electric screwdriver 10 according to Embodiment 1 fitting a screw S in the television receiver 100. FIG. 5 is a functional block diagram illustrating a configuration of main elements of the electric screwdriver 10 according to Embodiment 1. The following describes the configuration of the electric screwdriver 10 according to Embodiment 1 with reference to FIGS. 4 and 5.

The electric screwdriver 10 includes the light receiver 11 that receives the emitted light L that has exited through the light exit openings 74 and 93 of the television receiver 100, a fitting mechanism 13 that fits the screws S in the television receiver 100, a controller 12 (see FIG. 5) that controls driving of the fitting mechanism 13 based on a result of light reception by the light receiver 11, a notification section 14, and a switch 15.

The light receiver 11 has a casing 114. The casing 114 has an entrance opening 113 through which the emitted light L from the television receiver 100 enters the light receiver 11. The casing 114 houses a convex lens 111 for condensing the emitted light L that has entered through the entrance opening 113 and a light receiving element 112 for receiving the emitted light L that has passed through the convex lens 111. While the light receiving element 112 is receiving the emitted light L, the light receiver 11 according to the present embodiment transmits a signal indicating the light reception (referred to below as a “light reception signal”) to the controller 12.

The fitting mechanism 13 includes components such as an electric motor, not shown, and a screwdriver bit D that supports a screw S being worked on. The fitting mechanism 13 is driven by a drive controller 121 described below to fit the screws S to the screw holes 73 and 92 of the television receiver 100. Specifically, driven by the drive controller 121, the fitting mechanism 13 rotates the electric motor. The rotation of the electric motor is transmitted to the screwdriver bit D through an output shall, and thus the screwdriver bit D rotates. As a result, the screw S being supported by the screwdriver bit D rotates to be fitted in one set of screw holes 73 and 92 of the television receiver 100.

The controller 12 includes a central processing unit (CPU) and memory, not shown, and functions as the drive controller 121 and a notification controller 127 through the CPU executing various computer programs stored in the memory.

The drive controller 121 controls driving of the fitting mechanism 13. According to the present embodiment, the drive controller 121 drives the fitting mechanism 13 when the controller 12 is receiving the light reception signal from the light receiver 11, that is, when the light receiver 11 is receiving the emitted light L (when the light receiving element 112 is receiving the emitted light L). On the other hand, the drive controller 121 stops driving the fitting mechanism 13 when the controller 12 is not receiving the light reception signal from the light receiver 11. Note that the drive controller 121 does not have to control driving of the fitting mechanism 13 while the switch 15 is not being depressed.

According to the present embodiment, the light exit openings 74 and 93 are disposed in specific positions on the side walls 72 and 91, and the light receiver 11 is disposed in a specific position on the electric screwdriver 10 and in a specific orientation so that a central axis of the screw S being supported by the screwdriver bit D of the fitting mechanism 13 is at a desired angle (at substantially right angle, according to the present embodiment) to the side walls 72 and 91 when the light receiver 11 is receiving the emitted light L.

Thus, the central axis of the screw S is at substantially right angle to the side walls 72 and 91 when the light receiver 11 is receiving the emitted light L that has exited through the light exit opening 74 and 93. Through the switch 15 being depressed, the electric screwdriver 10 in such a state drives the fitting mechanism 13 to fit the screw S in one set of screw holes 73 and 92. Thus, according to the present embodiment, fitting of the screws S in the screw holes 73 and 92 is performed only when the central axis of the screw S being worked on is at substantially right angle to the side walls 72 and 91. It is therefore possible to prevent the screws S from being fitted in a tilted manner.

Under the control of the notification controller 127, the notification section 14 notifies a user of information about the result of light reception by the light receiver 11. According to the present embodiment, the notification section 14 is for example a lamp such as a light emitting diode (LED) and notifies the user of whether or not the light receiver 11 is receiving the emitted light L through the lamp being on or off. For example, the notification controller 127 turns on the notification section 14 if the controller 12 is receiving the light reception signal from the light receiver 11 and turns off the notification section 14 if the controller 12 is not receiving the light reception signal. Thus, the user can easily know whether or not the screw S is in a desired orientation (whether or not the central axis of the screw S is at substantially right angle to the side walls 72 and 91) through the notification section 14 being on or off, and therefore can easily decide whether or not to adjust the orientation of the screw S by shifting the electric screwdriver 10.

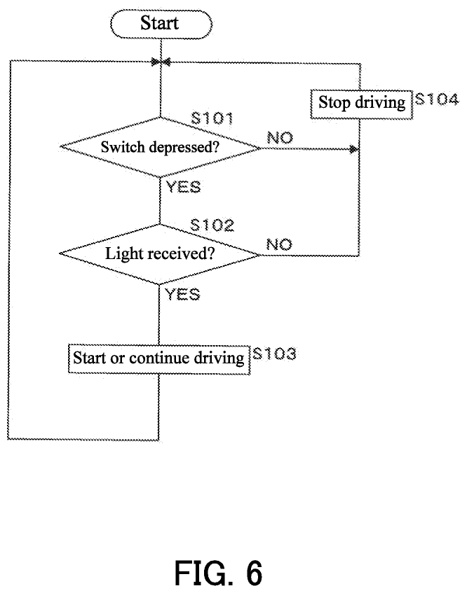

FIG. 6 is a flowchart of a process that is performed by the controller 12 of the electric screwdriver 10 according to Embodiment 1.

First, the controller 12 determines whether or not the switch 15 of the electric screwdriver 10 is being depressed (Step S101). Upon the controller 12 determining that the switch 15 is not being depressed (NO in Step S101), the drive controller 121 stops driving the fitting mechanism 13 if the fitting mechanism 13 is already driven (Step S104), and then the controller 12 waits until the switch 15 is depressed.

Upon determining that the switch 15 is being depressed (YES in Step S101), the controller 12 determines whether or not the light receiver 11 is receiving the emitted light L (Step S102). Specifically, the controller 12 determines that the light receiver 11 is receiving the emitted light L if the controller 12 is receiving the light reception signal from the light receiver 11. The notification controller 127 then turns on the notification section 14 if the light receiver 11 is receiving the emitted light L and turns off the notification section 14 if the light receiver 11 is not receiving the emitted light L.

Upon the controller 12 determining that the light receiver 11 is receiving the emitted light L (YES in Step S102), the drive controller 121 starts driving the fitting mechanism 13 if the fitting mechanism 13 is yet to be driven (Step S103). Thus, the screwdriver bit D and a screw S being supported by the screwdriver bit D are caused to rotate, and fitting of the screw S in one set of screw holes 73 and 92 of the television receiver 100 is started. The drive controller 121 continues to drive the fitting mechanism 13 if the fitting mechanism 13 is already driven (Step S103). Thereafter, the controller 12 advances the process to Step S101 and re-determines whether or not the switch 15 is being depressed.

Upon the controller 12 determining that the tight receiver 11 is not receiving the emitted light L (NO in Step S102), the drive controller 121 stops driving the fitting mechanism 13 if the fitting mechanism 13 is already driven (Step S104), and then the controller 12 advances the process to Step S101 and re-determines whether or not the switch 15 is being depressed.

As described above, the electric screwdriver 10 according to the present embodiment drives the fitting mechanism 13 to fit the screw S in one set of screw holes 73 and 92 of the television receiver 100 when the tight receiver 11 is receiving the emitted fight L. When the light receiver 11 is receiving the emitted tight L, the central axis of the screw S is at substantially right angle to the side walls 72 and 91. Thus, according to the present embodiment, fitting of the screws S in the screw holes 73 and 92 is performed only when the central axis of the screw S being worked on is at substantially right angle to the side walls 72 and 91. It is therefore possible to prevent the screws S from being fitted in a tilted manner.

The electric screwdriver 10 according to the present embodiment notifies the user of whether or not the light receiver 11 is receiving the emitted tight L through the notification section 14 being on or off Thus, the user can easily know whether or not the screw S is in a desired orientation, and therefore can easily decide whether or not to adjust the orientation of the screw S by shifting the electric screwdriver 10.

### Embodiment 2

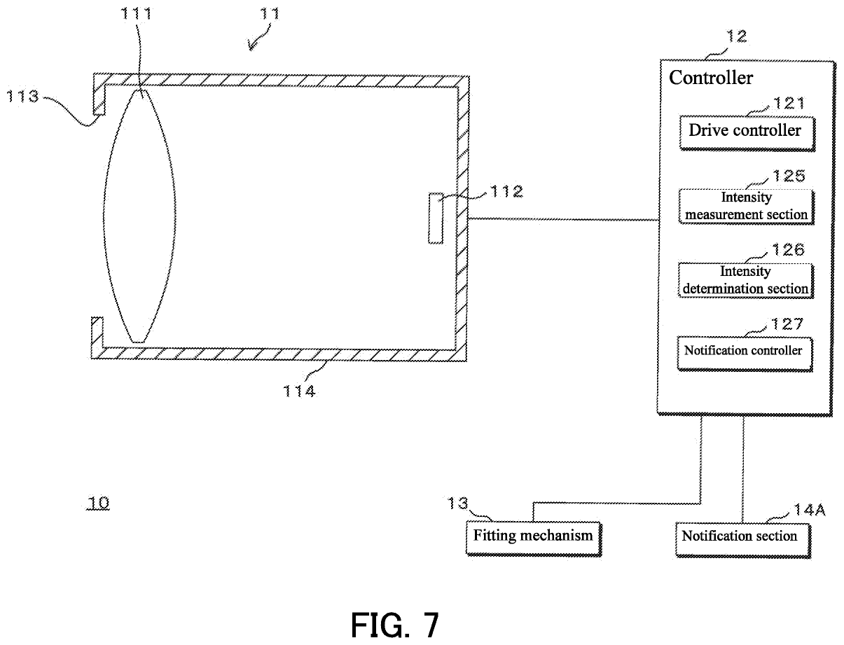

A machining system 1 according to Embodiment 2 has a similar configuration to the machining system 1 according to Embodiment 1 other than the configuration of the controller 12 and the notification section 14 of the electric screwdriver 10. The following mainly describes differences between Embodiments 2 and 1. FIG. 7 is a functional block diagram illustrating a configuration of main elements of an electric screwdriver 10 according to Embodiment 2.

According to Embodiment 2, a controller 12 of the electric screwdriver 10 functions as an intensity measurement section 125 and an intensity determination section 126 in addition to functioning as a drive controller 121 and a notification controller 127 through a CPU executing various computer programs stored in memory. The memory of the controller 12 for example stores therein data indicating a specific range of optical intensity of emitted light L that has entered a convex lens 111 (referred to below as a “specific intensity range”).

When the controller 12 receives a light reception signal from a light receiver 11, the intensity measurement section 125 measures the optical intensity of the received emitted light L, which in other words is the optical intensity of the emitted light L received by the light receiver 11. The intensity measurement section 125 for example measures the optical intensity of the received emitted light L using an optical intensity sensor.

The intensity determination section 126 determines whether or not the optical intensity of the received emitted light L measured by the intensity measurement section 125 (referred to below as a “measured optical intensity”) is within the specific intensity range stored in the memory. According to the present embodiment, the specific intensity range is a range of greater than or equal to a specific threshold value. Specifically, the emitted light L whose optical intensity is within the specific intensity range can be considered to be directed at an approximately 0° angle of incidence relative to the convex lens 111 of the light receiver 11. That is, the measured optical intensity being determined to be within the specific intensity range means that the emitted light L is entering the light receiver 11 (the convex lens 111) at an approximately 0° angle of incidence.

According to the present embodiment, the drive controller 121 drives a fitting mechanism 13 when the measured optical intensity is within the specific intensity range. Even when the light receiver 11 is receiving the emitted light L, however, the drive controller 121 does not drive the fitting mechanism 13 unless the measured optical intensity is within the specific intensity range.

According to the present embodiment, light exit openings 74 and 93 are disposed in specific positions on side walls 72 and 91, and the light receiver 11 is disposed in a specific position on the electric screwdriver 10 and in a specific orientation so that a central axis of a screw S being supported by a screwdriver bit D of the fitting mechanism 13 is at a desired angle (at substantially right angle, according to the present embodiment) to the side walls 72 and 91 when the measured optical intensity is within the specific intensity range.

Thus, the central axis of the screw S is at substantially right angle to the side walls 72 and 91 when the measured optical intensity is within the specific intensity, range. Through a switch 15 being depressed, the electric screwdriver 10 in such a state drives the fitting mechanism 13 to fit the screw S in one set of screw holes 73 and 92, Thus, according to the present embodiment, fitting of the screws S in the screw holes 73 and 92 is performed only when the central axis of the screw S being worked on is at substantially right angle to the side walls 72 and 91. It is therefore possible to prevent the screws S from being fitted in a tilted manner.

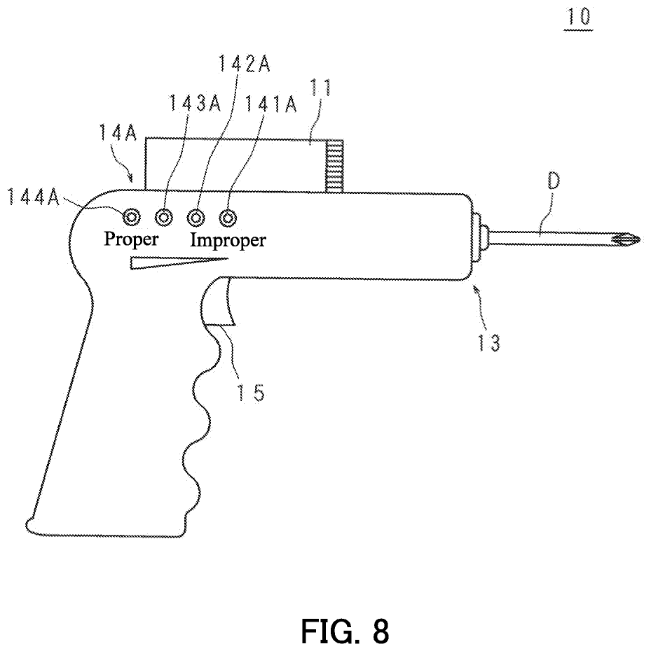

FIG. 8 is a diagram illustrating a configuration of a notification section 14A of the electric screwdriver 10 according to Embodiment 2.

The notification section 14A has a plurality of lamps 141A to 144A, Which are for example LEDs. The lamps 141A to 144A respectively correspond to a plurality of ranges related to the optical intensity (referred to below as “optical intensity ranges”), which according to the present embodiment are the following four ranges: a first range, a second range, a second range, a third range, and a fourth range. The fourth range is the specific intensity range and corresponds to the lamp 144A. The third range is a lower optical intensity range than the fourth range and corresponds to the lamp 143A. The second range is a lower optical intensity range than the third range and corresponds to the lamp 142A. The first range is a lower optical intensity range than the second range and corresponds to the lamp 141A. On the electric screwdriver 10, the word “Improper” is printed near the lamp 141A, and the word “Proper” is printed near the lamp 144A.

The intensity determination section 126 determines which of the optical intensity ranges (the first to fourth ranges) the measured optical intensity falls within. Hereinafter, this determination will be referred to as “intensity range determination”, Data indicating the optical intensity ranges other than the specific intensity range (the fourth range) are also stored in the memory of the controller 12. The intensity determination section 126 refers to the optical intensity ranges stored in the memory to perform the intensity range determination.

The notification controller 127 turns on an appropriate one of the lamps 141A to 144A based on a result of the intensity range determination. Specifically, the notification controller 127 turns on the lamp 141A upon the intensity determination section 126 determining that the measured optical intensity falls within the first range, turns on the lamp 142A upon the intensity determination section 126 determining that the measured optical intensity falls within the second range, turns on the lamp 143A upon the intensity determination section 126 determining that the measured optical intensity falls within the third range, and turns on the lamp 144A upon the intensity determination section 126 determining that the measured optical intensity falls within the fourth range. Among the lamps 141A to 144A, the lamps other than the lamp turned on stay off.

The four lamps 141A to 144A each being on or off indicate how close to 0° the angle of incidence of the emitted light L is relative to the light receiver 11. The closer to 0° the angle of incidence of the emitted light L is relative to the light receiver 11, the greater the measured optical intensity is. According to the present embodiment, the central axis of the screw S being supported by the screwdriver bit D of the fitting mechanism 13 is at a desired angle (at substantially right angle) to the side walls 72 and 91 when the angle of incidence of the emitted light L relative to the light receiver 11 is approximately 0°, that is, when the measured optical intensity is within the specific intensity range (the fourth range). The four lamps 141A to 144A each being on or off indicate how close to the desired angle the central axis of the screw S is. Specifically, the central axis of the screw S is indicated to be closer to the desired angle in the order of the lamp 141A being on, the lamp 142A being on, and the lamp 143A being on. The lamp 144A being on indicates that, the central axis of the screw S is at the desired angle.

Under the control of the notification controller 127, as described above, the notification section 14A notifies a user of information about the result of light reception by the light receiver 11, that is, which range the measured optical intensity falls by turning on an appropriate one of the lamps 141A to 144A. Thus, the user can easily know Whether or not the screw S is in a desired orientation and how close to the desired orientation the screw S is, and therefore can easily adjust the orientation of the screw S.

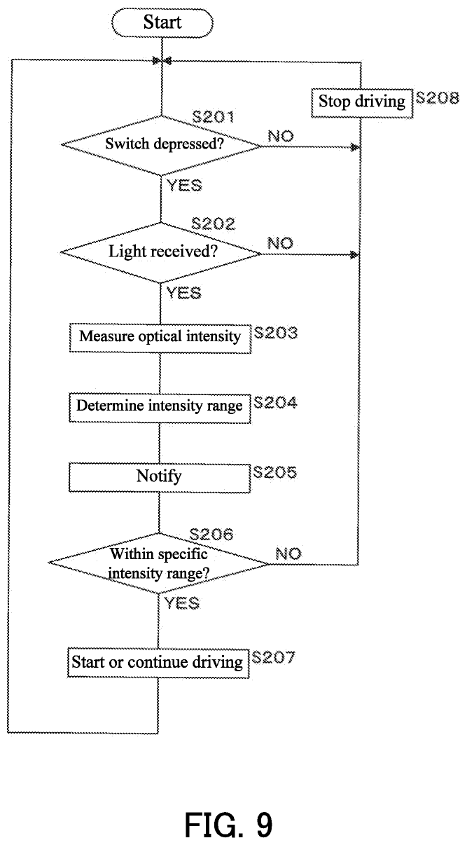

FIG. 9 is a flowchart of a process that is performed by the controller 12 of the electric screwdriver 10 according to Embodiment 2.

First, the controller 12 determines whether or not the switch 15 of the electric screwdriver 10 is being depressed (Step S201). Upon the controller 12 determining that the switch 15 is not being depressed (NO in Step S201), the drive controller 121 stops driving the fitting mechanism 13 if the fitting mechanism 13 is already driven (Step S208), and then the controller 12 waits until the switch 15 is depressed.

Upon determining that the switch 15 is being depressed (YES in Step S201), the controller 12 determines whether or not the light receiver 11 is receiving the emitted light L (Step S202). Specifically, the controller 12 determines that the light receiver 11 is receiving the emitted light L if the controller 12 is receiving the light reception signal from the light receiver 11.

Upon the controller 12 determining that the light receiver 11 is receiving the emitted light L (YES in Step S202), the intensity measurement section 125 measures the optical intensity of the received emitted light L (step S203).

Next, the intensity determination section 126 performs the intensity range determination based on the optical intensity of the received emitted light L measured by the intensity measurement section 125 (the measured optical intensity) and the optical intensity ranges (the first to fourth ranges) stored in the memory (Step S204).

Next, the notification controller 127 turns on an appropriate one of the tamps 141A to 144A based on a result of the intensity range determination and notifies a user of which optical intensity range the measured optical intensity falls within (Step S205).

Upon the intensity range determination determining that the measured optical intensity falls within the fourth range (the specific intensity range) (YES in Step S206), the drive controller 121 starts driving the fitting mechanism 13 if the fitting mechanism 13 is yet to be driven (Step S207). Thus, the screwdriver bit D and a screw S being supported by the screwdriver bit D are caused to rotate, and fitting of the screw S in one set of screw holes 73 and 92 of the television receiver 100 is started. The drive controller 121 continues to drive the fitting mechanism 13 if the fitting mechanism 13 is already driven (Step S207). Thereafter, the controller 12 advances the process to Step S201 and re-determines whether or not the switch 15 is being depressed.

Upon the controller 12 determining that the light receiver 11 is not receiving the emitted light L (NO in Step S202), or the intensity range determination determining that the measured optical intensity fails within a range other than the fourth range (the specific intensity range) (NO in Step S206), the drive controller 121 stops driving the fitting mechanism 13 if the fitting mechanism 13 is already driven (Step S208), and then the controller 12 advances the process to Step S201 and re-determines whether or not the switch 15 is being depressed.

As described above, the electric screwdriver 10 according to the present embodiment drives the fitting mechanism 13 to fit the screw S in one set of screw holes 73 and 92 of the television receiver 100 when the measured optical intensity is within the specific intensity range. The central axis of the screw S is at substantially right angle to the side walls 72 and 91 when the measured optical intensity is within the specific intensity range. Thus, according to the present embodiment, fitting of the screws S in the screw holes 73 and 92 is performed only when the central axis of the screw S being worked on is at substantially right angle to the side walls 72 and 91. It is therefore possible to prevent, the screws S from being fitted in a tilted manner.

According to the present embodiment, the electric screwdriver 10 notifies a user of which optical intensity range the measured optical intensity falls within by turning on an appropriate one of the lamps 141A to 144A. Thus, the user can know whether or not the screw S is in a desired orientation and how close to the desired orientation the screw S is, and therefore can easily adjust the orientation of the screw S.

The notification section 14A according to the present embodiment has the plurality of lamps 141A to 144A, but may alternatively have only one lamp as in Embodiment 1. In such a configuration, the notification section 14A may notify, under the control of the notification controller 127, the user of whether or not the measured optical intensity is within the specific intensity range through the notification section 14A being on or off. For example, the notification controller 127 may turn on the notification section 14A if the measured optical intensity is within the specific intensity range and turn off the notification section 14A if the measured optical intensity is not within the specific intensity range.

### Embodiment 3

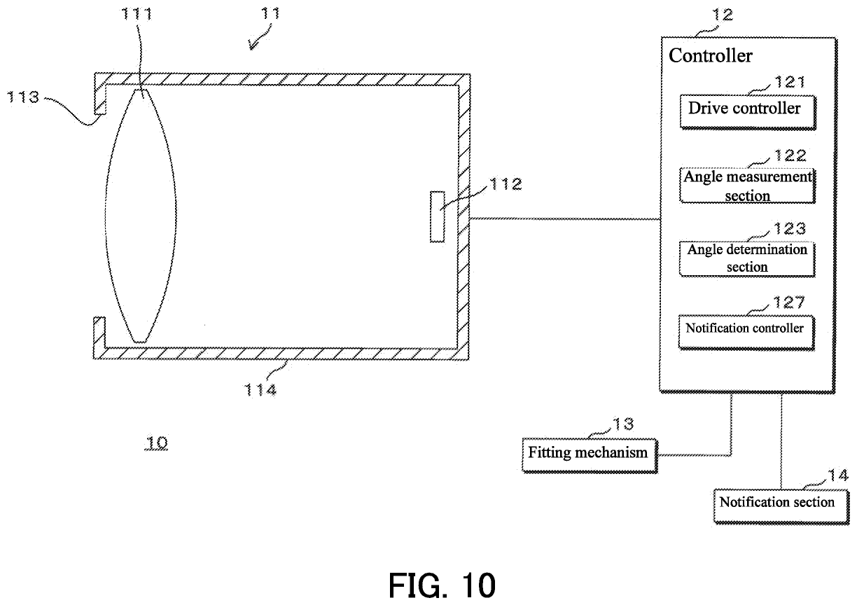

A machining system 1 according to Embodiment 3 has a similar configuration to the machining system 1 according to Embodiment 1 other than the configuration of the controller 12 of the electric screwdriver 10. The following mainly describes differences between Embodiments 3 and 1, FIG. 10 is a functional block diagram illustrating a configuration of main elements of an electric screwdriver 10 according to Embodiment 3.

According to Embodiment 3, a controller 12 of the electric screwdriver 10 functions as an angle measurement section 122 and an angle determination section 123 in addition to functioning as a drive controller 121 and a notification controller 127 through a CPU executing various computer programs stored in memory. The memory of the controller 12 for example stores therein data indicating a specific range of angle of incidence of emitted light L relative to a convex lens 111 (referred to below as a “specific angle range”).

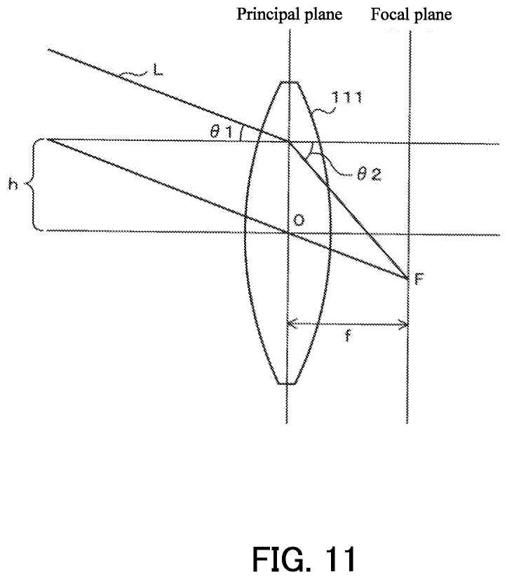

When the controller 12 receives a light reception signal from a light receiver 11, the angle measurement section 122 measures the angle of incidence of the received emitted light L, which in other words is the angle of incidence of the emitted light L relative to the convex lens 111, As illustrated in FIG. 11, the emitted light L that has entered the convex lens 111 at an angle of incidence θ1 is refracted by the convex lens 111, and then travels from a principal plane of the convex lens 111 to a focal point (a focal plane) F. The angle of incidence θ1 and an angle of refraction θ2 are in a relationship represented by equation 1 shown below. In equation 1, f represents a focal length. In equation 1, h represents a distance (a separation distance) from a center O of the convex lens 111 to a location on the principal plane through which the emitted light L has passed. Accordingly, the angle measurement section 122 can determine the angle of incidence θ1 by measuring the angle of refraction θ2, the separation distance h, and the focal length f.

tan θ2=h/f+tan θ1 equation 1

Referring back to FIG. 10, the angle determination section 123 determines whether or not the angle of incidence of the received emitted light L measured by the angle measurement section 122 (referred to below as a “measured angle of incidence”) is within the specific angle range stored in the memory. According to the present embodiment, the specific angle range is a range of approximately 0° (for example, a range of less than or equal to 0.5°).

According to the present embodiment, the drive controller 121 drives a fitting mechanism 13 when the measured angle of incidence is within the specific angle range. Even when the light receiver 11 is receiving the emitted light L, however, the drive controller 121 does not drive the fitting mechanism 13 unless the measured angle of incidence is within the specific angle range.

According to the present embodiment, light exit openings 74 and 93 are disposed in specific positions on side walls 72 and 91, and the light receiver 11 is disposed in a specific position on the electric screwdriver 10 and in a specific orientation so that a central axis of a screw S being supported by a screwdriver bit D of the fitting mechanism 13 is at a desired angle (at substantially right angle, according to the present embodiment) to the side walls 72 and 91 when the measured angle of incidence is within the specific angle range.

Thus, the central axis of the screw S is at substantially right angle to the side walls 72 and 91 when the measured angle of incidence is within the specific angle range. Through a switch 15 being depressed, the electric screwdriver 10 in such a state drives the fitting mechanism 13 to fit the screw S in one set of screw holes 73 and 92. Thus, according to the present embodiment, fitting of the screws S in the screw holes 73 and 92 is performed only when the central axis of the screw S being worked on is at substantially right angle to the side walls 72 and 91. It is therefore possible to prevent the screws S from being fitted in a tilted manner.

The notification section 14 is a lamp such as an LED as in Embodiment 1 and notifies, under the control of the notification controller 127, a user of whether or not the measured angle of incidence is within the specific angle range through the notification section 14A being on or off. For example, the notification controller 127 turns on the notification section 14 if the measured angle of incidence is within the specific angle range and turns off the notification section 14 if the measured angle of incidence is not within the specific angle range. Thus, the user can easily know whether or not the screw S is in a desired orientation (whether or not the central axis of the screw S is at substantially right angle to the side walls 72 and 91) through the notification section 14 being on or off, and therefore can easily decide whether or not to adjust the orientation of the screw S by shifting the electric screwdriver 10.

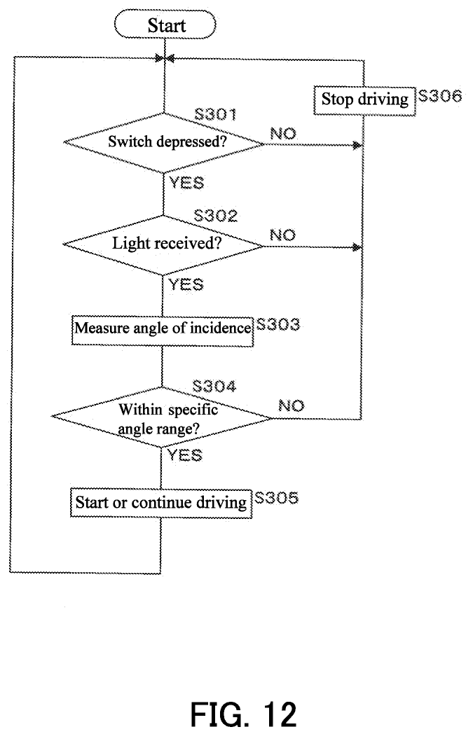

FIG. 12 is a flowchart of a process that is performed by the controller 12 of the electric screwdriver 10 according to Embodiment 3.

First, the controller 12 determines whether or not the switch 15 of the electric screwdriver 10 is being depressed (Step S301). Upon the controller 12 determining that the switch 15 is not being depressed (No in Step S301), the drive controller 121 stops driving the fitting mechanism 13 if the fitting mechanism 13 is already driven (Step S306), and then the controller 12 waits until the switch 15 is depressed.

Upon determining that the switch 15 is being depressed (YES in Step S301), the controller 12 determines whether or not the light receiver 11 is receiving the emitted light L (Step S302). Specifically, the controller 12 determines that the light receiver 11 is receiving the emitted light L if the controller 12 is receiving the light reception signal from the light receiver 11.

Upon the controller 12 determining that the light receiver 11 is receiving the emitted light L (YES in Step S302), the angle measurement section 122 measures the angle of incidence of the received emitted light L (step S303).

Next, the angle determination section 123 determines whether or not the measured angle of incidence is within the specific angle range based on the angle of incidence of the received emitted light L measured by the angle measurement section 122 (the measured angle of incidence) and the specific angle range stored in the memory (Step S304). The notification controller 127 turns on the notification section 14 if the measured angle of incidence is within the specific angle range and turns off the notification section 14 if the measured angle of incidence is not within the specific angle range.

Upon the angle determination section 123 determining that the measured angle of incidence is within the specific angle range (YES in Step S304), the drive controller 121 starts driving the fitting mechanism 13 if the fitting mechanism 13 is yet to be driven (Step S305). Thus, the screwdriver bit D and a screw S being supported by the screwdriver bit D are caused to rotate, and fitting of the screw S in one set of screw holes 73 and 92 of the television receiver 100 is started. The drive controller 121 continues to drive the fitting mechanism 13 if the fitting mechanism 13 is already driven (Step S305). Thereafter, the controller 12 advances the process to Step S301 and re-determines whether or not the switch 15 is being depressed.

Upon the controller 12 determining that the light receiver 11 is not receiving the emitted light L (NO in Step S302), or the angle determination section 123 determining that the measured angle of incidence is not within the specific angle range (NO in Step S304), the drive controller 121 stops driving the fitting mechanism 13 if the fitting mechanism 13 is already driven (Step S306), and then the controller 12 advances the process to Step S301 and re-determines whether or not the switch 15 is being depressed.

As described above, the electric screwdriver 10 according to the present embodiment drives the fitting mechanism 13 to fit the screw S in one set of screw holes 73 and 92 of the television receiver 100 when the measured angle of incidence is within the specific angle range. The central axis of the screw S is at substantially right angle to the side walls 72 and 91 when the measured angle of incidence is within the specific angle range, Thus, according to the present embodiment, fitting of the screws S in the screw holes 73 and 92 is performed only when the central axis of the screw S being worked on is at substantially right angle to the side walls 72 and 91. It is therefore possible to prevent the screws S from being fitted in a tilted manner.

The electric screwdriver 10 according to the present embodiment notifies the user of whether or not the measured angle of incidence is within the specific angle range through the notification section 14 being on or off. Thus, the user can easily know whether or not the screw S is in a desired orientation, and therefore can easily decide whether or not to adjust the orientation of the screw S by shifting the electric screwdriver 10.

### Embodiment 4

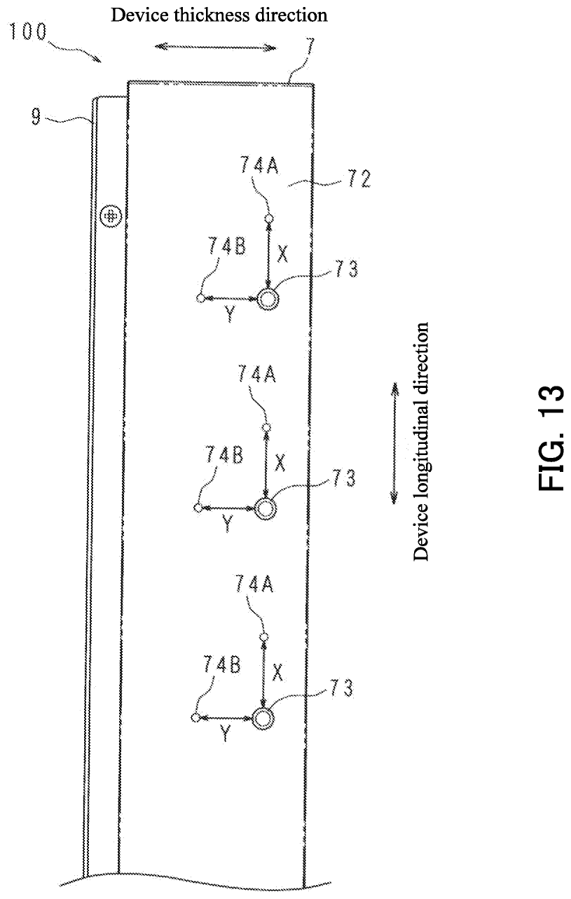

FIG. 13 is a diagram illustrating partial external appearance of a television receiver 100 according to Embodiment 4. FIG. 13 shows the television receiver 100 without screws S to facilitate explanation.

The television receiver 100 according to Embodiment 4 has a plurality of (two in the example illustrated in FIG. 13) sets of light exit openings 74 and 93 for each set of screw holes 73 and 92. Specifically, as illustrated in FIG. 13, one set of light exit openings (referred to below as “first light exit openings”) 74A and 93A is formed at a location a specific distance X away from one set of screw holes 73 and 92 in the device longitudinal direction, and another set of light exit openings (referred to below as “second light exit openings”) 74B and 93B is formed at a location a specific distance Y away from the one set of screw holes 73 and 92 in the device thickness direction. The arrangement of the sets of light exit openings 74 and 93 is not limited to that illustrated in FIG. 13.

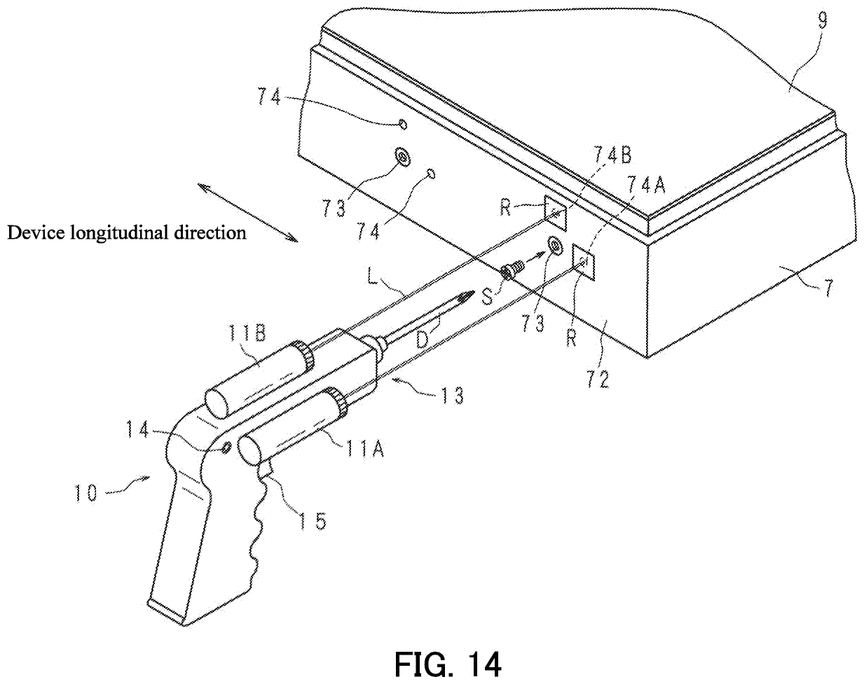

FIG. 14 is a diagram illustrating an electric screwdriver 10 according to Embodiment 4 fitting a screw S in the television receiver 100.

The electric screwdriver 10 according to Embodiment 4 includes a plurality of (two according to the example illustrated in FIG. 14) light receivers 11 respectively corresponding to the sets of light exit openings 74 and 93 formed for each set of screw holes 73 and 92. Specifically, the two light receivers 11 of the electric screwdriver 10 are a first light receiver 11A corresponding to the first light exit openings 74A and 93A, and a second light receiver 11B corresponding to the second light exit openings 74B and 93B. Each of the light receivers 11 receives emitted light L that has exited through the corresponding set of light exit openings 74 and 93.

A controller 12 of the electric screwdriver 10 according to the present embodiment controls driving of a fitting mechanism 13 based on a result of light reception by each of the respective light receivers 11. Specifically, the controller 12 has a similar configuration to the controller 12 according to any one of Embodiments 1 to 3 and operates as described below. That is, in a configuration in which the fitting mechanism 13 is driven when the light receiver 11 is receiving the emitted light L, the controller 12 performs a similar process to the process in the flowchart shown in FIG. 6. In this process, in Step S102, the controller 12 determines that the light receivers 11 are receiving the emitted light L if the first light receiver 11A is receiving the emitted light L that has exited through the first light exit openings 74A and 93A, and the second light receiver 11B is receiving the emitted light L that has exited through the second light exit openings 74B and 93B.

In a configuration in which the fitting mechanism 13 is driven when the measured optical intensity is within the specific intensity range, the controller 12 performs a similar process to the process in the flowchart shown in FIG. 9. In this process, in Step S202, the controller 12 determines that the light receivers 11 are receiving the emitted light L if the first light receiver 11A is receiving the emitted light L that has exited through the first light exit openings 74A and 93A, and the second light receiver 11B is receiving the emitted light L that has exited through the second light exit openings 74B and 93B. In Step S206, the controller 12 determines that the measured optical intensity falls within the fourth range (the specific intensity range) if the optical intensity of the received emitted light L that has exited through the first light exit openings 74A and 93A falls within the fourth range and the optical intensity of the received emitted light L that has exited through the second light exit openings 74B and 93B also falls within the fourth range.

In a configuration in which the fitting mechanists 13 is driven when the measured angle of incidence is within the specific angle range, the controller 12 performs a similar process to the process in the flowchart shown in FIG. 12. In this process, in Step S302, the controller 12 determines that the light receivers 11 are receiving the emitted light L if the first light receiver 11A is receiving the emitted light L that has exited through the first light exit openings 74A and 93A, and the second light receiver 11B is receiving the emitted light L that has exited through the second light exit openings 74B and 93B. In Step S304, the controller 12 determines that the measured angle of incidence is within the specific angle range if the angle of incidence of the received emitted light L that has exited through the first light exit openings 74A and 93A is within the specific angle range and the angle of incidence of the received emitted light L that has exited through the second light exit openings 74B and 93B is also within the specific angle range.

As described above, the electric screwdriver 10 according to the present embodiment determines whether or not to drive the fitting mechanism 13 based on the results of light reception by the plurality of (two, according to the present embodiment) light receivers 11 with respect to the emitted light L that has exited through the plurality of (two, according to the present embodiment) sets of light exit openings 74 and 93. According to the present embodiment, therefore, it is possible to detect misdirection of the central axis of the screw S being worked on more accurately than when the detection is performed based on a result of light reception by one light receiver 11. It is therefore possible to prevent the screw S from being fitted in a tilted manner more accurately.

Through the above, embodiments of the present invention have been described. However, the present invention is not limited to these embodiments, and various changes may be made therein without departing from the gist of the present invention.

For example, a lens member for enhancing the directionality of the emitted light L, such as a lens sheet R, may be disposed over the light exit openings 74 and 93 (see FIGS. 4 and 14). In such a configuration, the emitted light L passing through the lens sheet R is condensed and thus enhanced in directionality by the lens sheet R. As a result, the light receiver 11 receives the light more efficiently. The directionality of the emitted light L may be adjusted by changing the type of the lens sheet R. Note that the emitted light L according to the above-described embodiments is guided by the light exit openings 93 and 74, which are through holes having a depth larger than a diameter thereof, and thus has some directionality.

Some of the above-described embodiments may be combined. For example, Embodiment 2 and Embodiment 3 may be combined. In such a configuration, the controller 12 functions as the intensity measurement section 125, the intensity determination section 126, the angle measurement section 122, and the angle determination section 123 in addition to functioning as the drive controller 121 and the notification controller 127. Accordingly, the controller 12 may measure the optical intensity and the angle of incidence of the received emitted light L, so that the fitting mechanism 13 is driven when the measured optical intensity is within the specific intensity range and the measured angle of incidence is within the specific angle range, and the fitting mechanism 13 is not driven when the measured optical intensity is not within the specific intensity range or the measured angle of incidence is not within the specific angle range.

According to the above-described embodiments, the light exit openings 74 and 93 penetrate the side walls 72 and 91 at right angle to the planes of the side walls 72 and 91, and therefore the emitted light L travels in a direction orthogonal to the side walls 72 and 91. Accordingly, the light receiver 11 is disposed in a position (a position on the electric screwdriver 10) and in an orientation that allow the light receiver 11 to receive the emitted light L traveling in the direction orthogonal to the side walls 72 and 91 when the central axis of the screw S being supported by the screwdriver bit D is at substantially right angle to the side walls 72 and 91. However, the above-described arrangement of the light receiver 11 and the light exit openings 74 and 93 is merely an example, and the present invention is not limited thereto. For example, the light exit openings 74 and 93 may penetrate the side walls 72 and 91 in an oblique manner relative to the planes of the side walls 72 and 91 so that the emitted light L travels in a direction oblique to the side walls 72 and 91. In such a configuration, the light receiver 11 is disposed in a position and in an orientation that allow the light receiver 11 to receive the emitted light L traveling in the direction oblique to the side walls 72 and 91 when the central axis of the screw S being supported by the screwdriver bit D is at substantially right angle to the side walls 72 and 91.

According to the above-described embodiments (Embodiments 1 to 3), one set of light exit openings 74 and 93 is provided for each of the plurality of sets of screw holes 73 and 92. However, one set of light exit openings 74 and 93 may be provided for a plurality of sets of screw holes 73 and 92. For example, one set of light exit openings 74 and 93 may be provided for two adjacent sets of screw holes 73 and 92 at an intermediate location between the two adjacent sets of screw holes 73 and 92. In such a configuration, the electric screwdriver 10 can determine whether or not to drive the fitting mechanism 13 for fitting the screws S in the two sets of screw holes 73 and 92 based on a result of reception of the emitted light L that has exited through the set of light exit openings 74 and 93 provided at the intermediate location between the two sets of screw holes 73 and 92 (that is, based on whether or not the emitted light L is being received, whether or not the measured optical intensity of the emitted light L is within the specific intensity range, or whether or not the measured angle of incidence of the emitted light L is within the specific angle range), Thus, it is possible to reduce the number of light exit openings 74 and 93, and improve the appearance of the television receiver 100 as a product.

According to the above-described embodiments, the notification section 14 is a lamp such as an LED. However, the present invention is not limited thereto, and the notification section 14 may be any other device, such as a display, capable of notifying of information about the result of light reception by the light receiver 11.

The electric screwdriver 10 may for example be provided with a plurality of (for example, three) light receivers 11 aligned in a specific direction. In such a configuration, the electric screwdriver 10 may measure the optical intensity of the emitted light L received by each of the light receivers 11 and notify a user of the thus measured optical intensities. Knowing the optical intensity of the emitted light L received by each of the light receivers 11 aligned in the specific direction, the user can easily decide a side in the specific direction (for example, the front side or the back side of the television receiver 100, where the specific direction is the device thickness direction) the electric screwdriver 10 is to be shifted toward in order to adjust the screw S being worked on toward the desired orientation. Specifically, the user can adjust the screw S toward the desired orientation by shifting the electric screwdriver 10 toward the side having the light receiver 11 in which the highest optical intensity has been measured among the plurality of light receivers 11.

According to the above-described embodiments, the light receiver 11 transmits the signal indicating light reception (the light reception signal) to the controller 12 when the light receiver 11 is receiving the emitted light L, and the controller 12 determines that the light receiver 11 is receiving the emitted light L if the controller 12 is receiving the light reception signal. However, the present invention is not limited thereto. For example, the light receiver 11 may transmit a light reception start signal indicating start of light reception to the controller 12 when the light receiver 11 has started receiving the emitted tight L. The light receiver 11 may also transmit a light reception finish signal indicating finish of light reception to the controller 12 when the light receiver 11 has finished receiving the emitted light L. Accordingly, the controller 12 may determine that the light receiver 11 is receiving the emitted light L during a period from when the light reception start signal has been received to when the light reception finish signal has been received, and may otherwise determine that the light receiver 11 is not receiving the emitted light L.

According to the above-described embodiments, functions of the drive controller 121, the notification controller 127, the intensity measurement section 125, the intensity determination section 126, the angle measurement section 122, and the angle determination section 123 are implemented through the CPU executing the various computer programs stored in the memory (that is, implemented through software). However, these functions may be implemented through hardware.

For the above-described embodiments, the description is given using an example in which the user manually operates the electric screwdriver 10, However, the present invention is not limited thereto. For example, the machining system 1 according to the above-described embodiments can be applied to a situation in which the electric screwdriver is automatically controlled using vision recognition of a camera. In such a situation; the machining system 1 can omit a process of vision recognition and thus achieve cost reduction.

### REFERENCE SIGNS LIST

1 Machining system
10 Electric screwdriver
11 Light receiver
13 Fitting mechanism
14 Notification section
16 Light source
73, 92 Screw hole
7 Bezel
9 Backlight chassis
74, 93 Light exit opening
100 Television receiver
121 Drive controller
122 Angle measurement section
123 Angle determination section
125 Intensity measurement section
126 Intensity determination section
127 Notification controller
L Emitted light
R Lens sheet
S Screw

1. A machining system comprising:
a target device having a housing and a light source disposed within the housing; and
a fitting device configured to fit a fixing member in the housing, wherein
the target device has at least one light exit opening provided in the housing and configured to let out light emitted by the light source to an exterior of the housing as emitted light, and
the fitting device includes:
a fitting mechanism configured to be driven to fit the fixing member in the housing;
at least one light receiver configured to receive the emitted light that has exited through the at least one light exit opening; and
a drive controller configured to control driving of the fitting mechanism based on a result of light reception by the at least one light receiver.

2. The machining system according to claim 1, Wherein
the drive controller drives the fitting mechanism when the at least one light receiver is receiving the emitted light.

3. The machining system according to claim 2, wherein
the at least one light exit opening is disposed in a specific position on the housing, and the at least one light receiver is disposed in a specific position on the fitting device so that a central axis of the fixing member being supported by the fitting mechanism is at a desired angle to the housing when the at least one light receiver is receiving the emitted light.

4. The machining system according to claim 1, wherein
the fitting device further includes an intensity measurement section configured to measure an optical intensity of the emitted light when the emitted light is received by the at least one light receiver, and
the drive controller drives the fitting mechanism when the optical intensity is within a specific intensity range.

5. The machining system according to claim 1, wherein
the fitting device further includes an angle measurement section configured to measure an angle of incidence of the emitted light when the emitted light is received by the at least one light receiver, and
the drive controller drives the fitting mechanism when the angle of incidence is within a specific angle range.

6. The machining system according to claim 1, wherein
the fixing member is fitted in a through hole provided in the housing,
the at least one light exit opening comprises a plurality of light exit openings corresponding to the through hole,
the at least one light receiver comprises a plurality of light receivers in one-to-one correspondence with the plurality of light exit openings, and
the drive controller controls driving of the fitting mechanism based on a result of light reception by each of the plurality of light receivers.

7. The machining system according to claim 1, wherein
the fitting device further includes a notification section configured to notify of information about, the result of light reception by the at least one light receiver.

8. The machining system according to claim 1, Wherein
the housing has a lens member disposed over the at least one light exit opening and configured to adjust directionality of the emitted light.

9. A fitting device for fitting a fixing member in a housing of a target device, the target device having:
the housing;
a light source disposed within the housing; and
at least one light exit opening provided in the housing and configured to let out light emitted by the light source to an exterior of the housing as emitted light,
the fitting device comprising:
a fitting mechanism configured to be driven to fit the fixing member in the housing;
at least one light receiver configured to receive the emitted light that has exited through the at least one light exit opening; and
a drive controller configured to control driving of the fitting mechanism based on a result of light reception by the at least one light receiver.

10. The fitting device according to claim 9, wherein
the drive controller drives the fitting mechanism when the at least one light receiver is receiving the emitted light.

11. The fitting device according to claim 10, wherein
the at least one light exit opening is disposed in a specific position on the housing, and the at least one light receiver is disposed in a specific position on the fitting device so that a central axis of the fixing member being supported by the fitting mechanism is at a desired angle to the housing when the at least one light receiver is receiving the emitted light.

12. The fitting device according to claim 9, further comprising
an intensity measurement section configured to measure an optical intensity of the emitted light when the emitted light is received by the at least one light receiver, wherein
the drive controller drives the fitting mechanism when the optical intensity is within a specific intensity range.

13. The fitting device according to claim 9, further comprising
an angle measurement section configured to measure an angle of incidence of the emitted light when the emitted light is received by the at least one light receiver, wherein
the drive controller drives the fitting mechanism when the angle of incidence is within a specific angle range.

14. The fitting device according to claim 9, wherein
the fixing member is fitted in a through hole provided in the housing,
the at least one light exit opening comprises a plurality of light exit openings corresponding to the through hole,
the at least one light receiver comprises a plurality of light receivers in one-to-one correspondence with the plurality of light exit openings, and
the drive controller controls driving of the fitting mechanism based on a result f light reception by each of the plurality of light receivers.

15. The fitting device according to claim 9, further comprising
a notification section configured to notify of information about the result of light reception by the at least one light receiver.

16. The fitting device according to claim 9, wherein
the housing has a lens member disposed over the at least one light exit opening and configured to adjust directionality of the emitted light.

17. A method for controlling a fitting device for fitting a fixing member housing of a target device,
the target device having:
the housing;
a light source disposed within the housing; and
at least one light exit opening provided in the housing and configured to let out light emitted by the tight source to an exterior of the housing as emitted light,
the method comprising:
receiving the emitted light that has exited through the at least one light exit opening; and
controlling driving of a fitting mechanism for fitting the fixing member based on a result of the receiving of the emitted light.
